(19) United States
(12) Patent Application Publication
(10) Pub. No.: US 2013/0160279 A1
(43) Pub. Date: Jun. 27, 2013

(54) PROCESS CAP FOR FLAT SUBSTRATES AND PLANT AND METHOD FOR ONE-SIDED TREATMENT OF FLAT SUBSTRATES

(71) Applicants: Marcel SIEME, Fuerstenfeldbruck (DE); Michael Kellerer, Fuerstenfeldbruck (DE); Jens Eckstein, Dachau (DE)

(72) Inventors: Marcel SIEME, Fuerstenfeldbruck (DE); Michael Kellerer, Fuerstenfeldbruck (DE); Jens Eckstein, Dachau (DE)

(21) Appl. No.: 13/537,604

(22) Filed: Jun. 29, 2012

(30) Foreign Application Priority Data
Dec. 23, 2011 (DE) 202011109510.3

(51) Int. Cl. B05C 13/00; F26B 25/00; C03B 35/00

(52) U.S. Cl. 29/559; 269/287; 269/13; 34/236

(57) ABSTRACT

A process cap for protecting a top side of a flat substrate includes a cap and a seal. The seal is circumferentially arranged on a circumferential rim of the cap such that the cap effects a liquid-tight and vapor-tight closure between cap and flat substrate when the cap is fitted on a top side of the flat substrate. The process cap touches the flat substrate only in a circumferential rim area of the same, when it is fitted on the flat substrate and defines a fluid-tight space without any openings between process cap and flat substrate.

### CROSS-REFERENCE TO RELATED APPLICATIONS

This application claims priority from German Utility Model Application No. 202011109510.3, which was filed on Dec. 23, 2011, and is incorporated herein in its entirety by reference.

### BACKGROUND OF THE INVENTION

The present invention relates to a process cap for protecting a top side of flat substrates and a plant and a method for one-sided treatment of flat substrates.

Up to now, for example in photovoltaic industry, flat substrates, such as glass panes, are selectively processed, e.g. in cleaning and etching processes, in a one-sided manner in wet-chemical plants. Thereby, normally, the bottom side is treated with the process medium, while the top side has already passed other upstream processes and may not be damaged.

### SUMMARY

According to an embodiment, a process cap for protecting a top side of a flat substrate may have: a cap; a seal, which is circumferentially arranged on a circumferential rim of the cap such that the cap effects a liquid-tight and vapor-tight closure between cap and flat substrate when the cap is fitted on a top side of the flat substrate; and receiving portions, which are implemented to engage grippers of a cap maneuvering means, such that the process cap can be gripped by the grippers and can be maneuvered by the cap maneuvering means, wherein the process cap touches the flat substrate only in a circumferential rim area of the same, when it is fitted on the flat substrate and defines a fluid-tight space without any openings between process cap and flat substrate.

According to another embodiment, a plant for one-sided treatment of flat substrates may have: a cap maneuvering means, which is implemented to fit a process cap for protecting a top side of a flat substrate on the top side of the substrate, wherein the process cap includes a cap and a seal arranged circumferentially on a circumferential edge of the cap such that the cap effects a liquid-tight and vapor-tight closure between cap and flat substrate when the cap is fitted on a top side of the flat substrate, wherein the process cap touches the flat substrate only in a circumferential rim area when it is fitted on the flat substrate and defines a fluid-tight space without any openings between process cap and flat substrate; a transport means for transporting the flat substrate with the fitted process cap through one or several treatment stations where the bottom side of the flat substrate and/or an edge of the flat substrate between top side and bottom side is subject to treatment; wherein the cap maneuvering means is further implemented to detach the process cap from the flat substrate after treatment of the same in the one or several treatment stations.

The inventors have found out that during one-sided processing of a flat substrate, a side not to be treated can be damaged, even when the side not to be treated does not directly come into contact with a treatment liquid or a process medium. Vapors of the process medium can, for example, damage the side not to be treated, for example the top side. By specific airflow and exhaustion, this effect can be minimized but not avoided. Further, the inventors have found out that the edges of the substrate cannot be processed since there is the danger that the process medium reaches the top side. Thus, a separate process had been necessitated for edge treatment or processing.

The present invention is based on the knowledge that these problems can be solved by providing the side of the flat substrate not to be treated, for example the top side, with a process cap during treatment of the other side, for example the bottom side and/or the edges.

Embodiments of the invention provide a process cap for protecting a top side of a flat substrate comprising:

a cap; and

a seal, which is circumferentially arranged on a circumferential rim of the cap such that the cap effects a liquid-tight and vapor-tight closure between cap and flat substrate when the cap is fitted on a top side of the flat substrate,

wherein the process cap touches the flat substrate only in a circumferential rim area of the same, when it is fitted on the flat substrate and defines a fluid-tight space without any openings between process cap and flat substrate.

Further, embodiments of the invention provide a plant for one-sided treatment of flat substrates, comprising:

a cap maneuvering means, which is implemented to fit a respective process cap on a top side of a flat substrate;

a transport means for transporting the flat substrate with the fitted process cap through one or several treatment stations where the bottom side of the flat substrate and/or an edge of the flat substrate between the top side and the bottom side is subject to treatment,

wherein the cap maneuvering means is further implemented to detach the process cap from the flat substrate after treatment of the same in the one or several treatment stations.

Thus, embodiments of the invention provide a cover cap or process cap suitable for protecting a flat substrate, in particular when the flat substrate is to be treated wet-chemically in a one-sided manner. Further, embodiments of the invention provide a plant or production facility for selective one-sided wet-chemical processing of flat substrates using a process cap and having a process cap maneuvering system.

In embodiments of the process cap, the external dimensions of the circumferential rim are adapted to the external dimensions of the flat substrate, such that the circumferential rim of the cap does not project over the external edge of the flat substrate. Thus, it is easily possible to also process the edges of the flat substrate when the process cap is fitted without damaging the top side of the same.

In embodiments, the process cap touches the flat substrate only in a rim area of the flat substrate having a width of less than 20 mm, 10 mm or 5 mm when the process cap is fitted on the flat substrate. Thus, a negative effect on the top side of the flat substrate which can already be preprocessed can be reduced to a minimum.

In embodiments, the process cap has such a weight that merely by the weight of the process cap in connection with the seal, the liquid-tight and vapor-tight closure is obtained. Thus, no further means are necessitated for holding the process cap on the flat substrate while the same is processed. Correspondingly, embodiments of an inventive plant comprise no additional means for holding the process cap on the flat substrate.

In embodiments, the cap is integrally built of one material, which allows simple structure of the cap and ensures tightness. In embodiments, the cap can comprise a frame construction for stiffening.

In embodiments, the process cap comprises receiving portions implemented for engaging grippers of a cap maneuvering means, such that the process cap can be gripped by the grippers and can be maneuvered by the cap maneuvering means. The receiving portions can be implemented such that the process cap can be held in a defined position and in that way exact positioning on the substrate is possible.

In embodiments of an inventive plant, one or several treatment stations comprise one or several process modules in which the bottom side of the flat substrate and/or at least an edge of the flat substrate is treated by means of process liquid or process gas. During treatment of the flat substrate with the process medium, e.g. the process liquid or the process gas, the top side of the flat substrate can be protected by the process cap.

In embodiments of the plant, one or several treatment stations further comprise a flushing station for flushing the flat substrates treated with the process liquid or process gas. Thus, the process medium can be removed before detaching the process cap. In embodiments, further an exhaustion means can be provided, which is implemented to exhaust, after detachment of the process cap from the flat substrate, liquid residuals remaining at the edges and/or rims of the flat substrate. Embodiments comprise a drying station for drying the substrate and/or the process cap.

In embodiments, the cap maneuvering means is implemented to fit the cap in a fitting station onto the flat substrate, to detach the cap from the flat substrate in a detachment station and to return the cap from the detachment station to the fitting station.

In embodiments, the plant can be implemented to process several flat substrates simultaneously one after the other or in parallel. No separate discussion is necessitated that the plant can comprise a plurality of process caps to correspondingly provide protection for the several substrates to be processed.

By using a tight process cap, vapors of process media cannot negatively affect or damage the top side of the substrate to be protected. For this, the process cap includes a circumferential sealing providing liquid and vapor-tight closure between process cap and substrate. The seal is in such a condition that it can compensate production-caused unevennesses of substrate and process cap. Additionally, in embodiments, the seal is selected in shape and form such that the bearing surface is as small as possible and rests very close to the substrate rim.

In this production facility, the edges of the substrate can be processed, since the process cap rests with the seal on the top side of the substrate and hence when processing the edges no processing medium which would damage the surface can reach the top side protected by the process cap. Thus, no additional process for treating the edges is necessitated during production and hence costs and operating costs of a further plant can be saved.

### BRIEF DESCRIPTION OF THE DRAWINGS

Embodiments of the present invention will be detailed subsequently referring to the appended drawings, in which:

FIG. 1 is a schematic side view of a process cap;

FIGS. 2a and 2b are a schematic bottom view and a side view of a process cap;

FIG. 3 is a schematic illustration of a plant;

FIG. 4 is a schematic illustration of a process cap and a cap maneuvering means; and

FIG. 5 is a perspective view of an embodiment of a process cap.

### DETAILED DESCRIPTION OF THE INVENTION

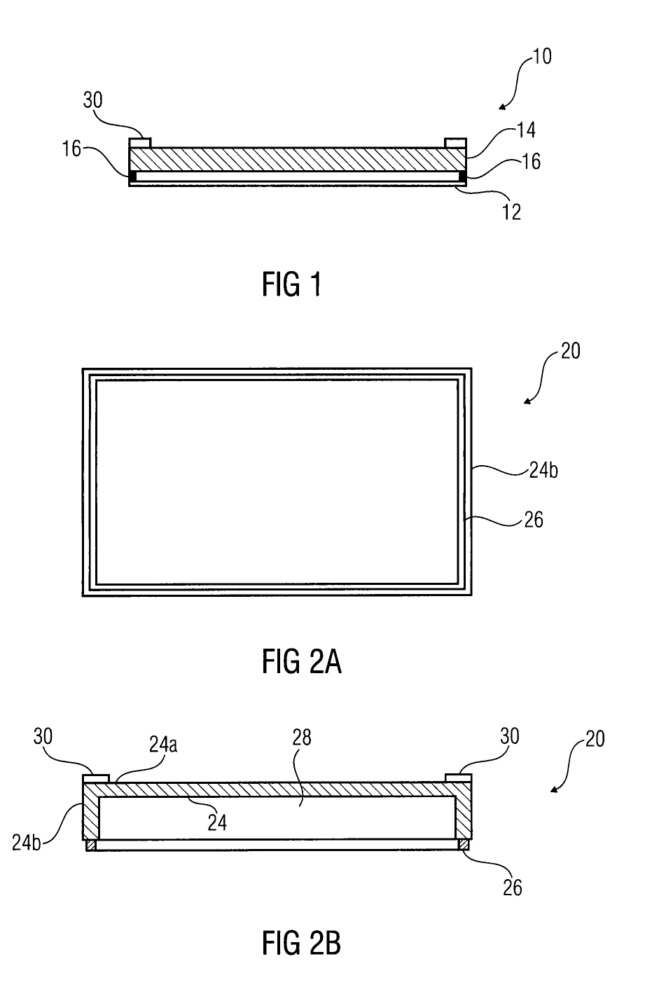

With reference to FIGS. 1 and 2, the structure of a process cap will at first be generally described below. The process cap represents a cover cap and will be referred to as process cap herein since it protects a primary side of a substrate to be processed during processing.

Here, a flat substrate can generally mean a flat body comprising a substantially (i.e. within a tolerance range of, for example 10%) constant thickness, and whose length and width dimension is many times (10 times, 50 times or 100 times) higher than its thickness dimensions. Thus, a flat substrate comprises two opposing primary sides and etches connecting the primary sides. Here, one-sided processing means processing where only one of the primary sides and optionally the edges are processed, but not the second primary side opposing the processed primary side.

In embodiments of the invention, the flat substrate can, in particular, be a glass pane or a semiconductor wafer. The flat substrate can be a glass pane or semiconductor wafer used for producing solar cells. Common wafers can, for example, have a length between 30 cm and 200 cm, a width between 30 cm and 300 cm and a thickness between 1 mm and 5 mm. Embodiments of the inventive process cap and the inventive plant can be adapted to such substrates.

FIG. 1 shows a cross-sectional view of a process cap 10 fitted on a substrate 12. As shown in FIG. 1, the process cap 10 essentially consists of two components, a cap construction or cap 14 and a seal 16. The cap consists of a material adapted to the purpose of the plant and the process media. For example, the cap could consist of a polymer material or a polymer material reinforced by carbon or glass fiber.

The cap construction can consists of bulk material (integral) or can have a frame construction for stiffening. The seal 16 is provided in a circumferential manner at the lower rim of the cap 14 and is implemented to compensate possible unevennesses of the substrate 12. When the process cap 10 is fitted on the substrate, the seal seals the inside of the process cap in a fluid-tight manner.

In the example shown in FIG. 1, the cap 14 is plate-shaped and is provided with the circumferential seal 16 at the lower external rim of the same. In this embodiment, the inside of the process cap can be defined merely by the remaining height of the seal 16 after fitting the process cap 10 on the substrate 12.

An alternative embodiment of a process cap 20 is shown in FIGS. 2a and 2b. As can be seen in FIG. 2b, the process cap 20 comprises a cap 24 and a seal 26. The cap 24 comprises a lid portion 24a and a rim portion 24b extending along the circumference of the lid portion at an angle to the same. For example, the edge portion 24b can extend at an angle of substantially 90° from the lid portion 24a. At the end of the rim portion 24b spaced apart from the lid portion 24a, the seal 26 is provided in a circumferential manner. When the process cap 24 is fitted on a flat substrate, the same forms, together with the substrate, a sealed closed cavity 28, by which the top side of the substrate is protected during processing of the bottom side or edges of the substrate.

In embodiments of the invention, the process cap has, independent of the structure, sufficient weight for obtaining a tight closure with the substrate via the weight in connection with the seal.

In embodiments of the invention, the process cap comprises receiving portions, by means of which the process cap can be received by a process cap maneuvering device. The receiving portions can be provided, for example, at the four corners of the process cap and are schematically indicated in FIGS. 1 and 2 by reference number 30. Alternatively, a lower number of receiving portions can be provided, for example one on each of the two sides of the process cap. The receiving portions can have any structure as long as they allow the process cap to be received, lifted, transported and lowered automatically by a process cap maneuvering device.

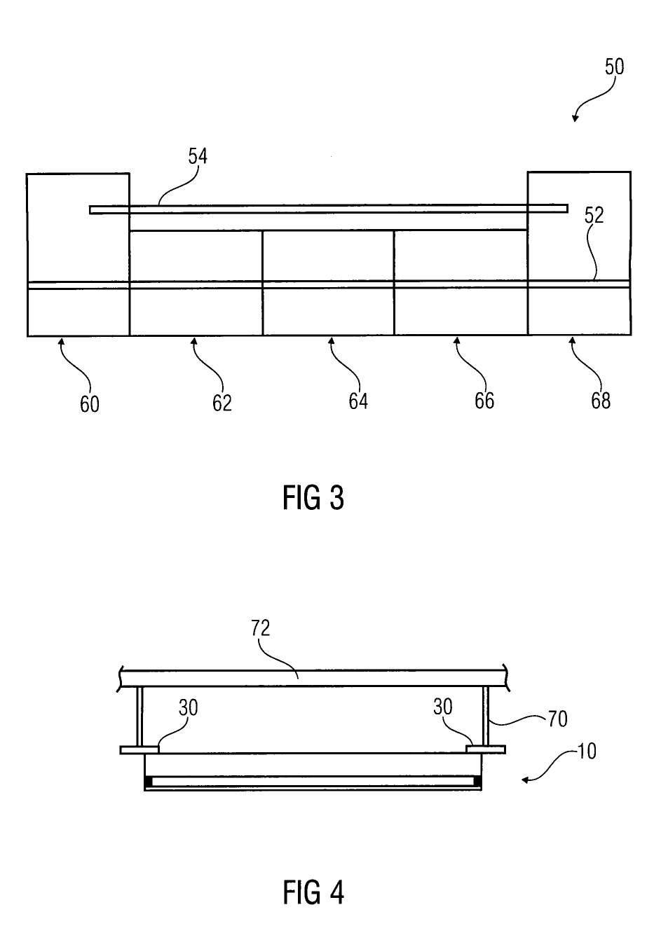

A schematic illustration of a production facility representing a plant for one-sided processing of flat substrates is shown in FIG. 3.

The plant 50 comprises different interconnected modules or stations. A transport system 52 is provided, which runs along the whole length of the plant 50 and serves to transport flat substrates through the plant 50. The transport system can consist of individual segments, wherein transfer of a flat substrate can take place between the modules or stations. The transport system can, for example, implement transport of substrates via a chain drive or a roller drive. A central control (not shown) can be provided to control all processes within the plant.

The plant 50 comprises a cap maneuvering system shown schematically in FIG. 3 and indicated by reference number 54. The cap maneuvering system can, for example, be a 2-axis transport system which is able to move process caps along two axes, namely a first axis along the path of the transport system 52 (for returning process caps along this path) and a second axis for fitting process caps on a substrate and detaching them from the same. The cap maneuvering system can be a 3-axis transport system, further being able to move the substrate in the direction of the third axis, which can be perpendicular to the first and second axes for exactly aligning a process cap with a substrate.

The plant 50 comprises an input module 60 where a substrate is accepted, for example from a previous module, where preprocessing of the substrate, for example also preprocessing of the top side of the same, could have taken place. In the input module, the process cap is fitted on the substrate by means of the cap maneuvering system to effect liquid-tight and vapor-tight closure between cap and flat substrate. Here, the cap maneuvering system can be implemented to receive the process cap, to move the same and to position the same with respect to the substrate, for example to center the same with respect to the substrate. For this purpose, the cap maneuvering system can comprise respective grippers engaging receiving portions (or engaging portions) of the process cap. After fitting, the cap maneuvering system releases the process cap by brining the grippers out of engagement with the receiving portion.

Further, the plant 50 comprises one or several process modules or process stations 62 where the bottom side of the substrate is subject to a treatment by a process medium. For example, a process module 62 can be provided for performing etching of the bottom side of the substrate. Further, a further process module 62 can be provided to effect edge treatment, for example edge etching of the substrate. For this purpose, the process module can comprise one or several carriages which can be moved along one or several edges of the substrate for effecting the respective treatment. Further, the plant can comprise one or several flushing modules 64 where flushing of the substrate is effected. Here, at least in some portions, flushing of the process cap can be performed. The process modules and the flushing modules have installations, such as a tank, pump, tubing, mechanical and electrical components, etc. adapted to the purpose of the plant. The structure of respective modules or stations is known to the person skilled in the art and necessitates no further explanation herein.

Further, the plant 50 comprises a drying module 66 where the substrate and the process cap are dried, for example by means of specific air streams (air knives).

The plant 50 comprises an output module 68 where the process cap is detached from the substrate. For this purpose, in the output module, grippers of the cap maneuvering system 54 engage the receiving portion of the process cap again and detach the same from the substrate. After detachment from the substrate, the process cap can be transported back to the input module 60 by the cap maneuvering system 54. For this purpose, the cap maneuvering system 54 can comprise a cap returning system connecting the input module 60 with the output module 68.

In embodiments, the output module 68 can comprise an exhaustion module which can comprise an exhaustion unit and exhaustion heads mounted at linear axes. The exhaustion module has the purpose of exhausting flushing water residuals on the substrate edges or substrate rims after detaching the process cap. Thus, contamination, in particular of the substrate top side, by such flushing water residuals can be avoided.

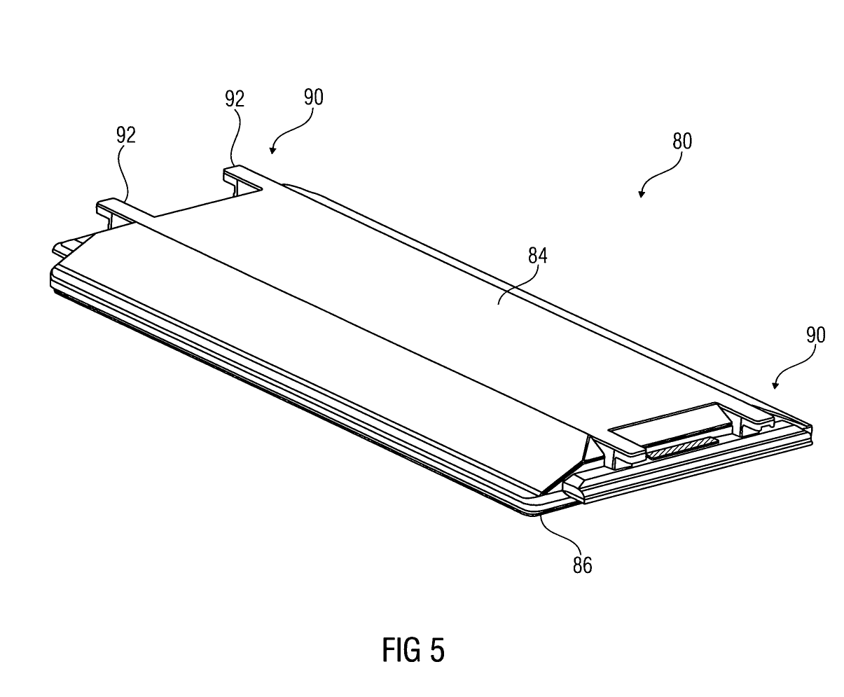

A schematic illustration of the process cap 10 of FIG. 1, where the gripper 70 of a cap maneuvering system 72 engages the receiving portions of the process cap 10 is shown in FIG. 4. For example, the process cap 10 can be lifted and lowered by means of the grippers 70 and can be moved horizontally (in parallel to the extension of the primary sides of the substrate) by means of the cap maneuvering system.

A perspective view of a specific embodiment of a process cap 80 is shown in FIG. 5. The process cap 80 comprises a cap 84 and a circumferential seal 86 mounted at the bottom rim of the cap. As shown in FIG. 5, receiving portions 90 are provided along the two short sides of the cap 84, which are implemented to engage matching grippers of a cap maneuvering system. In the shown embodiment, the receiving portions 90 comprise projections 92. For receiving the process cap, for example, matching grip elements of the cap maneuvering system can be pushed below the receiving portions 90 for supporting the process cap. Thereby, tabs of the grippers can engage tabs of the projections 92 for horizontally fixing the process cap.

In order to negatively affect as little as possible of the surface to be protected, the bearing surface of the seal or the substrate is selected to be minimum in embodiments of the invention. In embodiments, the seal can comprise a circumferential bearing surface width of less than 30 mm, 20 mm or 10 mm. In embodiments, the seal can comprise a circumferential bearing surface width of 12 mm to 13 mm, depending on the tolerance situation of the substrate size.

The present invention can be applied in a plurality of fields. In particular, the invention is suitable for processing glass panes or semiconductor wafers when producing thin-layer solar cells where the wafers have to be wet-chemically treated in a one-sided manner.

In embodiments of the invention, rear side and edges of thin layer solar cells can be simultaneously subject to wet-chemical treatment, for example etching or cleaning without negatively affecting active layers. Rear side etching by using brushes and chemicals can be performed. The inventive plant can be used for cleaning after furnace processes as well as for etching undesired coatings on the rear side and the edges of the substrate, such as CdTe or CdS.

Embodiments of the invention are particularly suitable for producing a—Si/μc—Si, CIS/CIGS and CdTe thin-layer solar cells, wherein the number of reduction steps can be reduced compared to known methods.

Embodiments of the inventive plant can be implemented to perform several different process steps. For example, the plant can be implemented to perform, when producing thin-layer solar modules, the following steps: one-sided cleaning of a glass substrate, rear side and edge cleaning of rim sputtering or rim vaporization, etc.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

Embodiments of the invention relate to a method of treating flat substrates, comprising:

fitting a process cap for protecting a top side of a flat substrate on the top side of the substrate, wherein the process cap comprises a cap and a seal arranged circumferentially on a circumferential edge of the cap such that the cap effects a liquid-tight and vapor-tight closure between cap and flat substrate when the cap is fitted on a top side of the flat substrate, wherein the process cap touches the flat substrate only in a circumferential rim area when it is fitted on the flat substrate and defines a fluid-tight space without any openings between process cap and flat substrate;

transporting the flat substrate with the fitted process cap through one or several treatment stations where the bottom side of the flat substrate and/or an edge of the flat substrate between top side and bottom side is subject to treatment;

detaching the process cap from the flat substrate after treatment of the same in the one or several treatment stations.

During the transport of the flat substrate the liquid-tight and vapor-tight closure may be merely achieved by the weight of the process cap in connection with the seal, wherein no additional means are provided to hold the process cap on the flat substrate. The bottom side of the flat substrate and/or at least an edge of the flat substrate may be treated by means of process liquid or process gas. Further treatment may comprise flushing or drying the substrate. The method may further comprise returning the cap from a detachment station to a fitting station.

1. A process cap for protecting a top side of a flat substrate, comprising:
a cap;
a seal, which is circumferentially arranged on a circumferential rim of the cap such that the cap effects a liquid-tight and vapor-tight closure between cap and flat substrate when the cap is fitted on a top side of the flat substrate; and
receiving portions, which are implemented to engage grippers of a cap maneuverer, such that the process cap can be gripped by the grippers and can be maneuvered by the cap maneuverer,
wherein the process cap touches the flat substrate only in a circumferential rim area of the same, when it is fitted on the flat substrate and defines a fluid-tight space without any openings between process cap and flat substrate.

2. The process cap according to claim 1, wherein the external dimensions of the circumferential rim are adapted to the external dimensions of the flat substrate such that the circumferential rim of the cap does not project over the external rim of the flat substrate.

3. The process cap according to claim 1, wherein the process cap touches the flat substrate only in a rim area of the substrate comprising a width of less than 30 mm, 20 mm or 10 mm when the process cap is fitted on the flat substrate.

4. The process cap according to claim 1, wherein the process cap comprises such a weight that merely by the weight of the process cap in connection with the seal the liquid-tight and vapor-tight closure is achieved.

5. The process cap according to claim 1, wherein the cap is integrally formed of one material.

6. The process cap according to claim 1, wherein the cap comprises a frame construction for stiffening.

7. A plant for one-sided treatment of flat substrates, comprising:
a cap maneuverer, which is implemented to fit a process cap for protecting a top side of a flat substrate on the top side of the substrate, wherein the process cap comprises a cap and a seal arranged circumferentially on a circumferential edge of the cap such that the cap effects a liquid-tight and vapor-tight closure between cap and flat substrate when the cap is fitted on a top side of the flat substrate, wherein the process cap touches the flat substrate only in a circumferential rim area when it is fitted on the flat substrate and defines a fluid-tight space without any openings between process cap and flat substrate;
a transporter for transporting the flat substrate with the fitted process cap through one or several treatment stations where the bottom side of the flat substrate and/or an edge of the flat substrate between top side and bottom side is subject to treatment;
wherein the cap maneuverer is further implemented to detach the process cap from the flat substrate after treatment of the same in the one or several treatment stations.

8. The plant according to claim 7, wherein during transporting the flat substrate by the transporter the liquid-tight and vapor-tight closure is merely achieved by the weight of the process cap in connection with the seal, wherein no additional means are provided to hold the process cap on the flat substrate.

9. The plant according to claim 7, wherein the one or several treatment stations comprise one or several process modules in which the bottom side of the flat substrate and/or at least an edge of the flat substrate is treated by means of process liquid or process gas.

10. The plant according to claim 9, wherein the one or several treatment stations further comprise a flushing station for flushing the flat substrate treated with the process liquid or the process gas.

11. The plant according to claim 7 comprising a drying station for drying the substrate and/or the process cap.

12. The plant according to claim 7, wherein the cap maneuverer is implemented to fit the cap onto the flat substrate in a fitting station, to detach the cap from the flat substrate in a detachment station and to return the cap from the detachment station to the fitting station.

13. The plant according to claim 7, further comprising an exhauster implemented to exhaust, after detaching the process cap from the flat substrate, liquid residuals remaining at the edges and/or rims of the flat substrate.

14. A method of treating flat substrates, comprising:
fitting a process cap for protecting a top side of a flat substrate on the top side of the substrate, wherein the process cap comprises a cap and a seal arranged circumferentially on a circumferential edge of the cap such that the cap effects a liquid-tight and vapor-tight closure between cap and flat substrate when the cap is fitted on a top side of the flat substrate, wherein the process cap touches the flat substrate only in a circumferential rim area when it is fitted on the flat substrate and defines a fluid-tight space without any openings between process cap and flat substrate;
transporting the flat substrate with the fitted process cap through one or several treatment stations where the bottom side of the flat substrate and/or an edge of the flat substrate between top side and bottom side is subject to treatment; and
detaching the process cap from the flat substrate after treatment of the same in the one or several treatment stations.
